(19) United States
(12) Patent Application Publication
(10) Pub. No.: US 2001/0033489 A1
(43) Pub. Date: Oct. 25, 2001

(54) Flora-Glo internally illuminated floral lamp

(76) Inventor: Christopher Wilson, Morgantown, WV (US)

Correspondence Address: Robert Platt Bell, Registered Patent Attorney, 8033 Washington Road, Alexandria, VA, 22308, US

(21) Appl. No.: 09/765,397

(22) Filed: Jan. 22, 2001

Related U.S. Application Data
(60) Provisional application No. 60/179,150, filed on Jan. 31, 2000.

(51) Int. Cl. F21S 13/04

(52) U.S. Cl. 362/252; 362/806

(57) ABSTRACT

A glass bottle or other container contains a substantial portion of a string of miniature bulbs. A hole formed in the base of the container allows the power cord and plug to emerge near the base. Another portion of the holiday lighting string may be gathered together in bunch to form a proto-bulb at the neck of the bottle. The lights within the bottle produce an ambient lighting effect, while the lights bunched at the neck of the bottle may produce limited task lighting. The bottle itself may be further enhanced and decorated by applying dried or artificial flowers to the surface of the bottle in an applique fashion to allow light to pass through the flowers, enhancing the lighting effect. A lamp shade and lamp shade fixture may be applied to the bottle to support a convention shade for shading the proto-bulb.

### CROSS-REFERENCE TO RELATED APPLICATIONS

The present application claims priority from Provisional U.S. patent application Ser. No. 60/179,150, filed Jan. 31, 2000 and incorporated herein by reference.

### FIELD OF THE INVENTION

The present invention relates to the field of lighting an illumination, particularly to decorative table lamps. In particular, the present invention is directed toward a decorative table lamp made from a bottle or bottle-like structure, having internal illumination by means of miniature lights with a floral applique applied to the exterior surfaces.

### BACKGROUND OF THE INVENTION

Numerous decorative, utilitarian, and novelty lighting apparatus are known in the prior art. For home use, most users prefer a lighting apparatus which is both decorative and utilitarian. A lamp should provide ambient lighting which has a pleasing effect and at the same time be aesthetically pleasing in physical appearance. A lamp which produces glare or a garish light is not useful. A lamp which is displeasing in appearance is unwanted.

Bottles have been converted for lamp use for some time. Leeds, U.S. Design Pat. No. Des. 268,210, issued Mar. 8, 1983 and incorporated herein by reference, shows a lamp made from a bottle. Most Prior Art bottle lamps are of the variety shown by Leeds, where a fairly standard 110 Volt light fixture is installed at the neck of the bottle, facing up, and the bottle forming a base for the lamp. Indeed, it is even known in the art to purchase “kits” having a light fixture attached to a cork for creating such lamps from discarded bottles.

While the design of Leeds produces a pleasing lamp, the lighting effect is little different than that from a standard table lamp. Moreover, unless the bottle has some different or unusual decoration or shape, the overall aesthetic design of the lamp is somewhat limited in appeal and taste.

Decorating with miniature light strings (i.e., so-called “Christmas Tree Lights”) is also well known in the art. An example of such a light set is the “GE Gala Lights” light set, sold by the General Electric Company. Such sets typically comprise a number of miniature bulbs (e.g., 20, 35, 50, or 100), typically ½″ in length, connected in parallel or series using a thin insulated braided wire of approximately 16 gauge, usually having green insulation for Christmas tree use.

The use of such miniature bulbs for ambient lighting purposes has been discovered by many individuals to produce a pleasing, indirect, lighting effect. Strings of such lights, for example, can be stapled to a wall or ceiling to produce an indirect and subdued lighting effect.

However, generally such holiday decoration lights are not suitable for year-round use as utility lighting fixtures. Strings of lights can get caught by loose clothing or appendages and thus present a risk for electrical shock or fire hazard. Running staples through strings of lights raises the dangerous possibility of puncturing the insulative covering on such lights. Most holiday mini-lamp manufacturers, for this reason, do not recommend using miniature lamps for other than ornamental holiday display.

Pisani. U.S. Pat. No. 5,555,163, issued Sep. 10, 1996 and incorporated herein by reference, discloses a display made using such ornamental Christmas lights. Pisani provides a board having a number of holes for receiving individual bulbs. Various symbols, words, or images may be produced by placing bulbs into individual holes, much as in a manner of the Hasbro™ LITEBRITE™ lighting toy (which utilized translucent colored pegs with a backlit background).

While the Pisani device does contain the wires of a Christmas light string, the resulting light is not suitable for use as an ambient lighting fixture, but rather is more of a novelty device.

Thus, in the Prior Art, there remains no lamp which provides the pleasant ambient lighting effect of a holiday light string in a safe and portable housing. Moreover, there exists no bottle style lamp with a suitably aesthetic ornamental appearance.

### SUMMARY OF THE INVENTION

The present invention solves the problems of the Prior Art by providing a lighting fixture which is both aesthetically pleasing in appearance and aesthetically pleasing in lighting effect. In addition, taking advantage of readily recyclable materials and inexpensive holiday lighting strings, the apparatus of the present invention can be produced at a relatively reasonable cost.

In the present invention a glass bottle or other container (including a container specifically designed for such purpose) contains a substantial portion of a holiday lighting string using miniature bulbs. A hole may be formed in the container for the power cord and plug to emerge near the base. Another portion of the holiday lighting string may be gathered together in bunch to form a proto-bulb at the neck of the bottle. The lights within the bottle produce an ambient lighting effect, while the lights bunched at the neck of the bottle may produce limited task lighting.

The bottle itself (or container provided explicitly for such purpose) may be further enhanced and decorated by applying dried flowers (or artificial flowers) to the surface of the bottle in an applique fashion. Thus use of such applique allows light to pass through the natural (or artificial) flowers, further enhancing the lighting effect and producing pleasant coloration.

A lamp shade and lamp shade fixture may be applied to the bottle to support a convention shade for shading the proto-bulb. Alternately, a glass shade may be used, in a color contrasting or complimenting the bottle and flower colors, to enhance the overall lighting effect.

### BRIEF DESCRIPTION OF THE DRAWINGS

FIG. 1 is a perspective view of the wire lampshade holder portion of the present invention.

FIG. 2 is a perspective view of the wire lampshade holder portion of FIG. 1 illustrating how the wire portion may be inserted into the bunched lamps forming the proto-bulb at the bottle neck.

FIG. 3 is a side view illustration of a bottle with a hole formed therein for the lamp cord.

FIG. 4 is a side view illustration of the bottle of FIG. 3 with flower applique formed thereon.

FIG. 5 is a partially exploded perspective view illustration of the lamp of the present invention.

### DETAILED DESCRIPTION OF THE INVENTION

Flora-Glo™, a handmade one-of-a-kind, nature-art luminaire lamp, is a decorative and useful gift item that utilizes the serene beauty of a summer flower garden to create new-found charm in any room in the home, protected outdoor living areas, the office, dorm rooms, shops, stores, restaurants, or almost anywhere. The Flora-Glo™ is a perfect wedding, anniversary, house-warming, birthday, special occasion, holiday, graduation, new baby, or show-of-love gift.

The Flora-Glo™ luminaire lamp is a one-of-a-kind nature-art luminaire lamp created with natural pressed flowers and foliage applied to a recycled glass bottle and illuminated from the inside and out the top (resembling a candle flame) with mini-lights. This unique creation is handmade by artisans on a recycled bottle, thus preserving the environment.

The mini-lights that are used to illuminate these lamps create a soft, enchanting ambiance. The lights radiate through the flowers and foliage, providing you and your home the comfortable warmth and vitality of a flower garden, any time or season. This unique lighting design is sure to enhance any decor, create a pleasing personality for any room, and stimulate conversation.

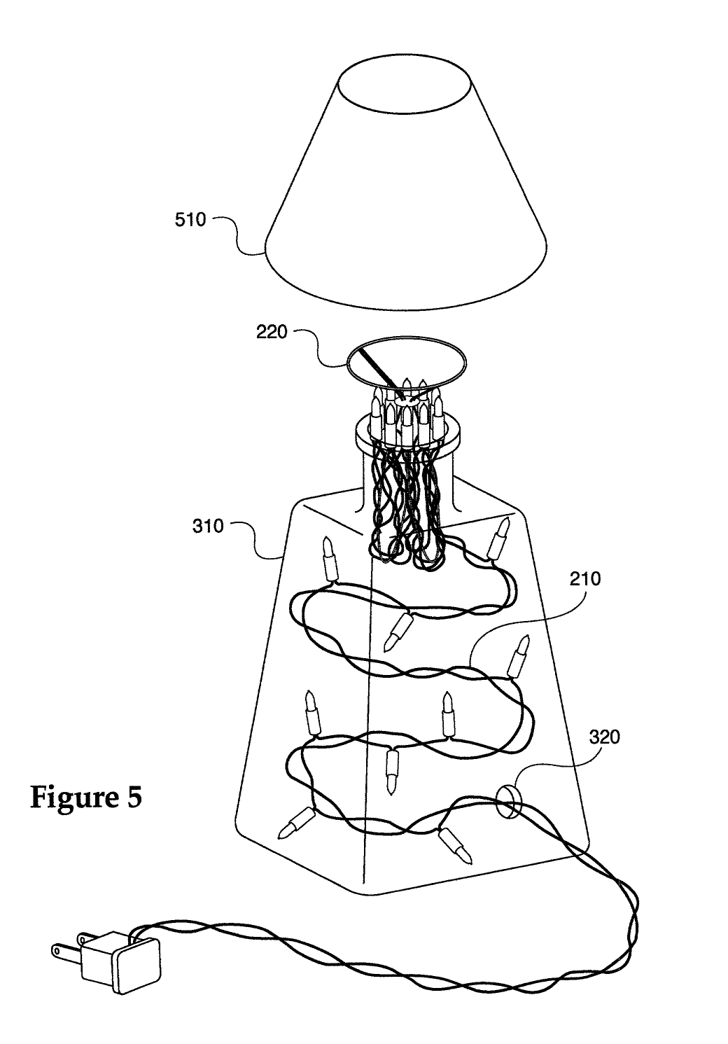

FIG. 5 is a partially exploded perspective view illustration of the lamp of the present invention. FIG. 5 illustrates most of the features of the present invention in perspective view. The lamp of FIG. 5 may comprise a bottle 310 having a hole 320 formed therein allowing a string of Christmas lights 210 to pass therethrough.

Christmas lights 210 may be bunched into a bundle providing an attractive and indirect lighting effect through the sides of bottle 310. A portion of Christmas lights 210 may be bunched together into a proto-bulb and placed in the neck of bottle 310. Lampshade holder (optional) 210 may be pressed into this bunch of Christmas lights 210 to support glass lamp shade 510.

Glass lampshade 510 may of course be substituted with other types of lampshades, including convention paper, fabric, or wood lamp shades, without departing from the spirit and scope of the present invention. In addition, the lamp of FIG. 5 may be provided with or without a lampshade 510 or lampshade holder 220. The portion of lamps bunched into the proto-bulb may be left intact, or, in the alternative, may be placed within the bottle to provide aesthetic pleasing lighting effect.

The shape and size of bottle 310 in the Figures is by way of example only. Bottle 310 may be provided in a number of shapes, sizes, and colors. Variations of the present invention may be viewed at www.floraglo.com. Lamps may also be purchased through this site.

Bottle 310 may comprise any one of a number of liquor or other type of bottles, or may even comprise an antique bottle or decanter. In addition, bottle 310 may comprise a container designed and manufactured especially for the purposes of the present invention. Moreover, bottle 310 may also be suitably (although not preferredly) made of plastic, acrylic, or some other material, without departing from the spirit and scope of the present invention.

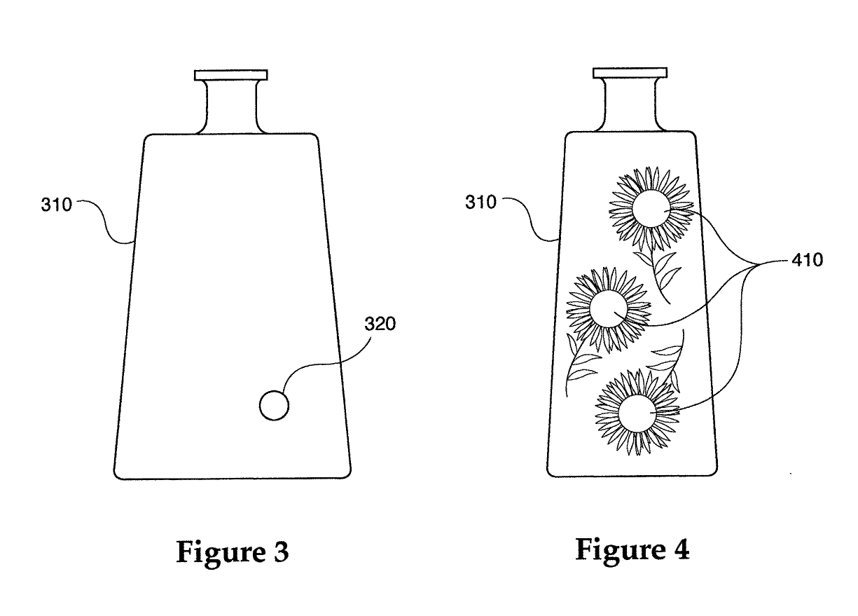

FIG. 3 is a side view illustration of a bottle with a hole formed therein for the lamp cord. Hole 320 may be formed using a ½″ diamond core bit. A drill press may be used, and coolant (e.g., water) should be provided to prevent glass breakage. Hole 320 may be optional. However, the use of hole 320 allows the lamp cord to pass through the bottle near the base. If the lamp cord were to pass through the neck of the bottle, it may tend to tip over the bottle of pulled or jostled. Moreover, hole 320 allows the lamp cord to exit the bottle at a lower position, which is a more aesthetically pleasing appearance.

FIG. 4 is a side view illustration of the bottle of FIG. 3 with flower and foliage 410 applique formed thereon. Although bottle 310 may be provided without decoration, in the preferred embodiment of the present invention, a floral or other type of applique may be provided to enhance the aesthetic appearance of the lamp. The design of FIG. 4 is by way of schematic only and may nor represent the overall detail and intricacy of the applied flower designs.

Flowers and foliage 410 may comprise pressed, dried flowers, including, but not limited to Pansy, Columbine, Cosmos, Verbena, Queen Anne's Lace, Delphinium, Gaillardia, Lobelia, Phlox, Geranium, Johnny Jump-ups, Jolly Jokers, Butterfly Weed, Goldenrod, Larkspur, and Coral Bells. In addition, foliage such as, but not limited to Woodwardia, Fern Leaf Yarrow, Tansy, Queen Anne's Lace foliage, Rabbit's Foot fern, and Maidenhair fern may be applied to the bottle.

Flowers and foliage 410 may be first dried and pressed using conventional techniques. Flowers and foliage 410 may then be applied using a paint brush and MOD PODGE matte finish adhesive (Plaid Enterprises, Norcross Ga. 30091). When the initial application of MOD PODGE has dried, the entirety of bottle 310 may receive a coat of MOD PODGE, again applied with a paint brush.

Once this second application of MOD PODGE has dried, the entire bottle may be coated, again with a brush, with a latex gloss finish such as “Gloss Clear Protector” manufactured by Enterprise Paint Co. of Wheeling, Ill. 60090. Two to three coats of the latex gloss coating may be applied.

Although illustrated herein as using flowers and foliage 410, other types of applique may be used without departing from the spirit and scope of the present invention. For example, artificial flowers may be used, if of suitable quality. Photographs, slides, or transparencies of various sorts may also be used to provide a translucent image which may be illuminated from within. For example, a large transparency image of an individual, logo, or design may be used.

Referring back to FIG. 5, once the outer coatings (if used) have dried, Christmas lights 210 (preferably a 20 or 35 light string) may be pushed through hole 320, one by one, until the entire string 210 is within bottle 310. A hook or the like may be used to pull a portion of Christmas lights 210 through the neck of the bottle.

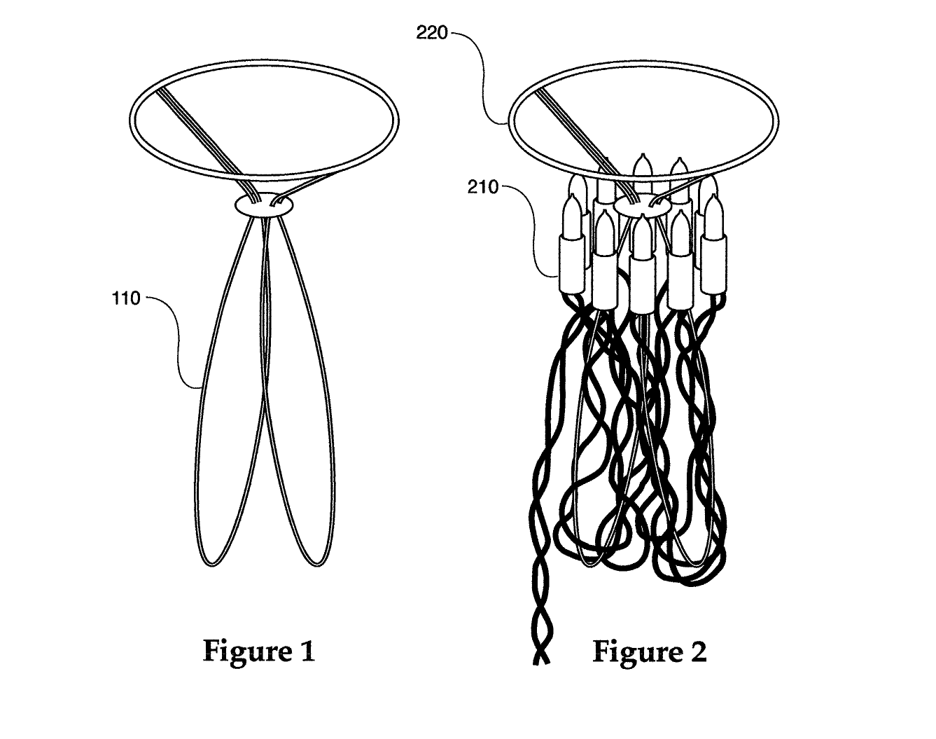

FIG. 2 is a perspective view of the wire lampshade holder portion of FIG. 1 illustrating how the wire portion may be inserted into the bunched lamps forming the proto-bulb at the bottle neck. Once a portion of Christmas lights 210 has been pulled through the neck of bottle 310, they may be bunched together and pressed into the neck of bottle 310 to form a proto-bulb. The term proto-bulb as used herein refers to a bunched portion of Christmas lamps 210 pressed together to give the lighting effect of a single lamp bulb. The number of lights for the proto-bulb may vary depending on the neck size of the bottle.

FIG. 1 is a perspective view of the wire lampshade holder portion of the present invention. Lampshade 510 may be supported by wire lampshade holder 110 which may have a wire loop portion suitable for insertion into the proto-bulb of FIG. 2. Once inserted into the proto-bulb, wire lampshade holder 110 may support lampshade 510 as illustrated in FIG. 5.

The lamp design may be suitably further decorated by tying raffia around the neck of the bottle as decoration and to hold a certificate of authenticity/contact card.

While the preferred embodiment and various alternative embodiments of the invention have been disclosed and described in detail herein, it may be apparent to those skilled in the art that various changes in form and detail may be made therein without departing from the spirit and scope thereof.

For example, as a home of office lighting product, the FLORA-GLO™ may be utilized with standard electrical accessories such as extension cords (e.g., 4 to 6 feet), light timers, and the like.

I claim:

1. A lamp comprising:
an at least translucent container having an opening formed at a top end thereof and a hole, formed near a bottom base portion of the at least translucent container; and
a string of miniature light bulbs, the string of miniature light bulbs comprising:
a first substantial portion of the string of miniature light bulbs located within the at least translucent container,
a second portion of the string of miniature lights gathered together in bunch to form a proto-bulb at the opening of the at least translucent container, and
a power cord, coupled to the first and second portions of the string of miniature light bulbs, extending through the hole formed near a bottom base portion of the at least translucent container;
wherein the first substantial portion of the string of miniature lights within the at least translucent container produce an ambient lighting effect, while the second portion of the string of miniature lights gathered together in bunch to form a proto-bulb at opening of the at least translucent container produces limited task lighting.

2. The lamp of claim 1, wherein the at least translucent container is further enhanced and decorated by applied dried natural flowers to the surface of the at least translucent container in an applique fashion so as to allow light to pass through the dried natural flowers, further enhancing the lighting effect and producing pleasant coloration.

3. The lamp of claim 1, wherein the at least translucent container is further enhanced and decorated by applied artificial flowers to the surface of the at least translucent container in an applique fashion so as to allow light to pass through the artificial flowers, further enhancing the lighting effect and producing pleasant coloration.

4. The lamp of claim 2, further comprising:
a lamp shade for shading the proto-bulb; and
a lamp shade fixture, coupled to the at least translucent container to support the lamp shade.

5. The lamp of claim 4, wherein the shade comprises a glass shade, in a color contrasting or complimenting the at least translucent container and flower colors, to enhance the overall lighting effect.

6. A method of making an attractive lamp, comprising the steps of:
Forming a hole in an at least translucent container,
drying and pressed flowers and/or foliage,
applying the flowers and/or foliage using a matte finish adhesive,
covering the at least translucent container with an additional coat of matte finish adhesive,
coating the at least translucent container with at least one coat of a latex gloss finish,
inserting a string of Christmas lights through the hole, one by one, until the entire string is within the at least translucent container,
using a hook to pull a portion of the Christmas lights through the neck of the at least translucent container,
bunching together a portion of the Christmas lights, and
pressing the bunched portion of Christmas lights into the neck of the at least translucent container to form a proto-bulb.

7. The method of claim 6, further comprising:
inserting a wire lampshade holder having a wire loop portion inserted into the proto-bulb,
placing the lampshade on the wire lampshade holder.

8. The method of claim 5, wherein the flowers and foliage comprise at least one or more of:
Pansy, Columbine, Cosmos, Verbena, Queen Anne's Lace, Delphinium, Gaillardia, Lobelia, Phlox, Geranium, Johnny Jump-ups, Jolly Jokers, Butterfly Weed, Goldenrod, Larkspur, Coral Bells, Woodwardia, Fern Leaf Yarrow, Tansy, Queen Anne's Lace foliage, Rabbit's Foot fern, and Maidenhair fern.

9. A lamp comprising:
a glass bottle having a neck opening formed at a top end thereof and a hole, formed near a bottom base portion of the glass bottle;
a string of miniature light bulbs, the string of miniature light bulbs comprising:
a first substantial portion of the string of miniature light bulbs located within the glass bottle,
a second portion of the string of miniature lights gathered together in bunch to form a proto-bulb at the neck of the glass bottle, and
a power cord, coupled to the first and second portions of the string of miniature light bulbs, extending through the hole formed near a bottom base portion of the glass bottle;
dried flowers applied to the surface of the glass bottle in an applique fashion;
a lamp shade for shading the proto-bulb; and
a lamp shade fixture, coupled to the glass bottle to support the lamp shade;
wherein the first substantial portion of the string of miniature lights within the glass bottle produce an ambient lighting effect so as to allow light to pass through the glass bottle and dried flowers producing an enhanced lighting effect and pleasant coloration, while the second portion of the string of miniature lights gathered together in bunch to form a proto-bulb at opening of the glass bottle produces limited task lighting.
